(19) United States
(12) Patent Application Publication
(10) Pub. No.: US 2024/0040418 A1
(43) Pub. Date: Feb. 1, 2024

(54) Method And Apparatus For Reference Signal Enhancements In Mobile Communications

(71) Applicant: MediaTek Inc., Hsinchu City (TW)

(72) Inventors: Yi-Ju Liao, Hsinchu City (TW); Din-Hwa Huang, Hsinchu City (TW); Wei-De Wu, Hsinchu City (TW); Chien-Chun Cheng, Hsinchu City (TW)

(21) Appl. No.: 18/209,764

(22) Filed: Jun. 14, 2023

Related U.S. Application Data
(60) Provisional application No. 63/369,390, filed on Jul. 26, 2022.

(51) Int. Cl. H04W 24/10; H04L 5/00

(52) U.S. Cl. CPC H04W 24/10; H04L 5/0051

(57) ABSTRACT

Examples pertaining to reference signal (RS) enhancements in mobile communications are described. An apparatus (e.g., a user equipment (UE)) may receive a minimum broadcast RS from a network node (e.g., a base station (BS)). Based on the minimum broadcast RS, the apparatus may perform basic downlink (DL) measurement. The apparatus may also receive or transmit an on-demand RS from or to the network node in a case that a triggering condition is fulfilled. Based on the on-demand RS, the apparatus may perform additional DL or uplink (UL) measurement.

### CROSS REFERENCE TO RELATED PATENT APPLICATION(S)

The present disclosure is part of a non-provisional application claiming the priority benefit of U.S. Patent Application No. 63/369,390, filed 26 Jul. 2022, the content of which herein being incorporated by reference in its entirety.

### TECHNICAL FIELD

The present disclosure is generally related to mobile communications and, more particularly, to method and apparatus for reference signal (RS) enhancements in mobile communications.

### BACKGROUND

Unless otherwise indicated herein, approaches described in this section are not prior art to the claims listed below and are not admitted as prior art by inclusion in this section.

Power saving is one of the most important issues in any wireless communication system, and its importance is even more relevant for mobile devices, such as smartphones, which have limited amount of power source (e.g., battery) comparing to other type of devices, such as fixed wireless customer premise equipment (CPE) or devices mounted on a vehicle. This issue has become more important in 5th Generation (5G) New Radio (NR) since it has been observed that mobile devices (and even the base stations) tend to consume power more quickly when they are operating in 5G NR than in other legacy technologies (e.g., Long-Term Evolution (LTE)).

In 5G NR, reference signal (RS) is periodically broadcasted by a base station (BS) (e.g., a gNB). FIG. 1 illustrates an example scenario 100 of conventional RS transmissions in 5G NR. In scenario 100, a user equipment (UE) (denoted as UE1 in FIG. 1) is associated with a sparse traffic application (e.g., instant messaging (IM)), i.e., the downlink (DL) data for the UE only comes once in a while, and when it does, the BS arranges data scheduling and sends the DL data to the UE. Meanwhile, the UE may wake up for DL data reception and also for RS reception when needed. Other than that, the UE may enter a low-power mode or sleep mode to save power. In addition to the occasional DL data scheduling, the BS has to keep broadcasting RS with a short periodicity such as 20 milliseconds (ms), even when there's no DL data activity and/or the UE is in the sleep mode. As a result, the BS's sleep will be interrupted by the unnecessary RS transmissions, which leads to undesirable waste of power. It is estimated that the broadcast RS transmissions may consume up to 30 percent of BS's power.

Therefore, a solution is sought to improve the power saving issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to RS enhancements in mobile communications.

In one aspect, a method may involve a processor of an apparatus (e.g., UE) receiving a minimum broadcast RS from a network node. The method may also involve the processor performing basic downlink (DL) measurement based on the minimum broadcast RS. The method may also involve the processor receiving or transmitting an on-demand RS from or to the network node in a case that a triggering condition is fulfilled. The method may also involve the processor performing additional DL or uplink (UL) measurement based on the on-demand RS.

In another aspect, a method may involve a processor of an apparatus (e.g., network node) transmitting a minimum broadcast RS for basic DL measurement to all UEs. The method may also involve the processor transmitting or receiving an on-demand RS for additional DL or UL measurement to or from a specific UE in a case that a triggering condition is fulfilled.

In yet another aspect, an apparatus may comprise a transceiver which, during operation, wirelessly communicates with a network node of a wireless network. The apparatus may also comprise a processor communicatively coupled to the transceiver. The processor, during operation, may perform operations comprising receiving, via the transceiver, a minimum broadcast RS from the network node; performing, via the transceiver, basic DL measurement based on the minimum broadcast RS; receiving or transmitting, via the transceiver, an on-demand RS from or to the network node in a case that a triggering condition is fulfilled; and performing, via the transceiver, additional DL or UL measurement based on the on-demand RS.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of conventional RS transmissions in 5G NR.

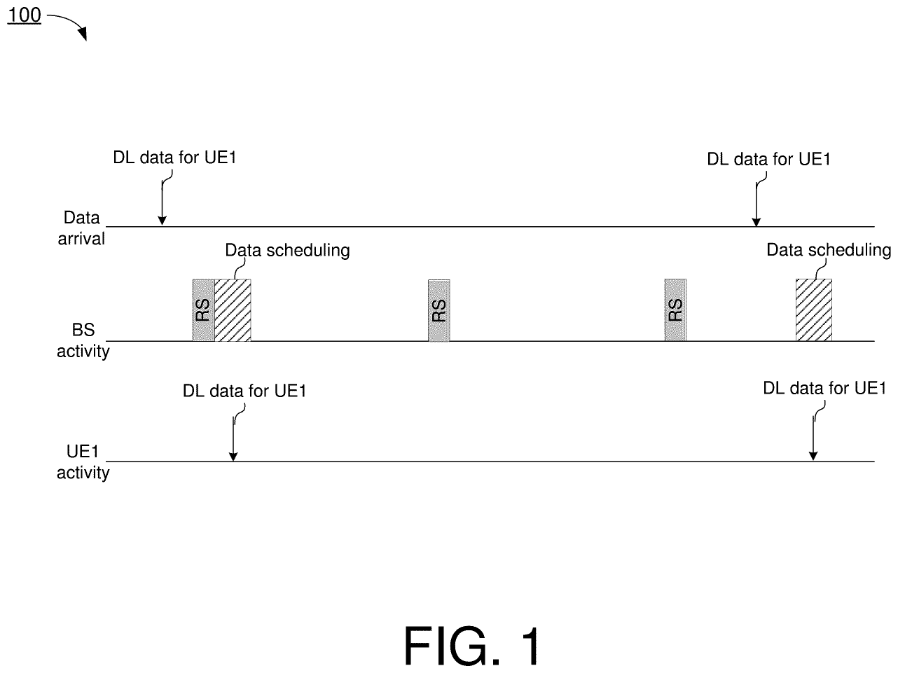

FIG. 2 is a diagram depicting an example scenario of novel RS transmissions under schemes in accordance with implementations of the present disclosure.

FIG. 3 is a diagram depicting an example scenario of triggering on-demand RS under schemes in accordance with implementations of the present disclosure.

FIG. 4 is a diagram depicting an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to RS enhancements in mobile communications. According to the present disclosure, a number of possible solutions may be implemented separately or jointly. That is, although these possible solutions may be described below separately, two or more of these possible solutions may be implemented in one combination or another.

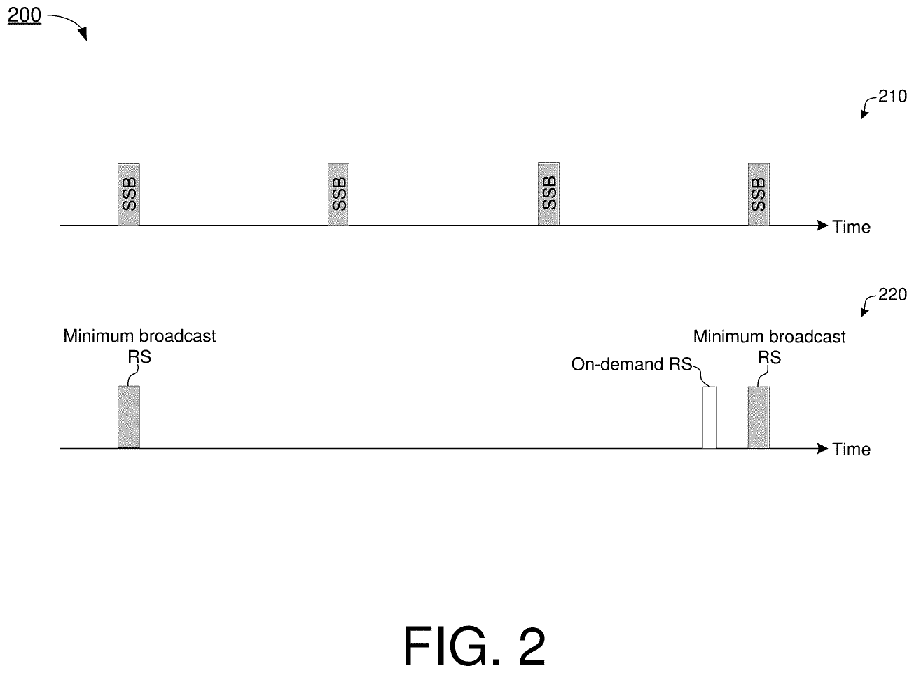

FIG. 2 illustrates an example scenario 200 of novel RS transmissions under schemes in accordance with implementations of the present disclosure. Diagram 210 depicts the conventional RS (e.g., SSB) transmission scheme in 5G NR, where the RS/SSB is broadcasted with a short periodicity (e.g., 20 ms). In diagram 210, the broadcast RS/SSB transmission is periodically performed regardless of whether a UE is in sleep mode or not. Diagram 220 depicts the novel RS transmission scheme for beyond 5G (B5G) or 6th Generation (6G), where minimum broadcast RS is transmitted with a long periodicity (e.g., 80 ms) and UE-specific or cell-specific on-demand RS is transmitted when certain triggering condition is fulfilled (e.g., on-demand RS is transmitted only to UE(s) of high mobility or UE(s) at cell edge). Specifically, the minimum broadcast RS is used for basic DL measurement (e.g., initial cell search, time and/or frequency synchronization, beam management, radio link monitoring (RLM), and/or radio resource management (RRM)), while the on-demand RS is used for additional DL or uplink (UL) measurement (e.g., link or beam recovery, handover procedure, and/or RRM). The minimum broadcast RS and the on-demand RS may be received by a UE via the same radio or different radios. The DL/UL resources of the on-demand RS may be shared among UEs. It is noteworthy that, compared to the short RS periodicity (e.g., 20 ms) in diagram 210, the long RS periodicity (e.g., 80 ms) in diagram 220 may have a significant gain of 34.3 percent in BS power saving for sparse traffic (e.g., IM).

In some implementations, the minimum broadcast RS may be transmitted using a lower power and used for coarse time and/or frequency synchronization and measurement, while the on-demand RS may be transmitted using a higher power and used for fine time and/or frequency synchronization and accessing network.

In some implementations, a UE may report capability information indicating whether the UE supports the on-demand RS to the BS, and the BS may configure, via higher layer signaling, a set of time and frequency resources for DL/UL on-demand RS to the UE based on the UE's capability information. The BS may configure the triggering condition for DL/UL on-demand RS to the UE via higher layer signaling. The UE may perform basic DL measurement based on the minimum broadcast RS. To trigger on-demand RS for additional DL/UL measurement, the following implementations may be considered. In some implementations, the UE may transmit a request to the BS to trigger DL/UL on-demand RS when the triggering condition is fulfilled (this scenario is referred to hereafter as request-based triggering of on-demand RS). The request may be transmitted via physical uplink control channel (PUCCH), physical uplink shared channel (PUSCH), physical random access channel (PRACH), or a sequence with periodic resource which is configured by higher layer signaling. In some implementations, the BS may determine the UE's mobility, location, or channel condition by sensing, and accordingly, the BS may indicate the UE to perform additional DL/UL measurement based on the on-demand RS (this scenario is referred to hereafter as indication-based triggering of on-demand RS). The indication may be included in one of the following: (1) higher layer signaling, e.g., system information block (SIB) or UE-specific radio resource control (RRC) signaling, (2) medium access control (MAC) control element (CE), and (3) layer one (L1)-based signaling.

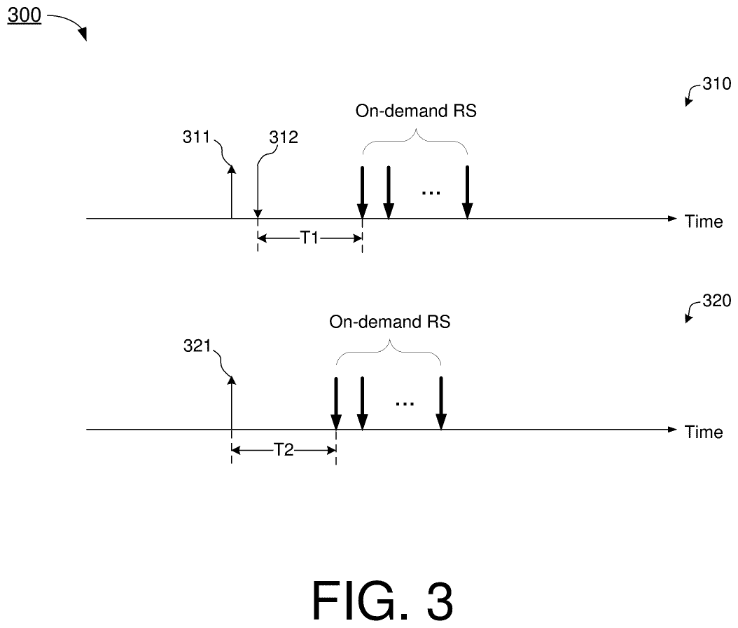

FIG. 3 illustrates an example scenario 300 of triggering on-demand RS under schemes in accordance with implementations of the present disclosure. Diagrams 310 and 320 depict different schemes for request-based triggering of on-demand RS. In diagram 310, the UE transmits a request 311 to the BS to trigger the on-demand RS, and then receives a response 312 from the BS. After receiving the response 312 (e.g., after a period of time T1 subsequent to the reception of the response 312), the UE may receive the on-demand RS and perform additional DL/UL measurement based on the on-demand RS. The period of time T1 may be configured by the BS via higher layer signaling or may be defined in 3^{rd} Generation Partnership Project (3GPP) technical specification (TS). In one example, the response may be transmitted via L1 signaling, e.g., PDCCH, and the response may include on-demand RS resource indication, i.e., which RS resource in a configured resource set is used, or on-demand RS activation. In one example, the response may be transmitted via MAC CE, and it may include on-demand RS resource indication, i.e., which RS resource in a configured resource set is used, or on-demand RS activation. In one example, the response may be transmitted via higher layer signaling, e.g., UE-specific RRC signaling, and it may include resource configuration of on-demand RS (in this case, preconfigured resource set for on-demand RS is not necessary). In one example, the response may indicate which on-demand RS type, i.e., DL or UL on-demand RS, is used if both are supported by the BS and the UE. In diagram 320, the UE transmits a request 312 to the BS to trigger the on-demand RS, and after a period of time T2 subsequent to the transmission of the request 312), the UE may receive the on-demand RS (i.e., without waiting for a response from the BS) and perform additional DL/UL measurement based on the on-demand RS. The period of time T2 may be configured by the BS via higher layer signaling or may be defined in 3GPP TS.

For request-based triggering of on-demand RS, the triggering condition may include a “Good serving cell quality” criterion and/or a “Low mobility” criterion. Specifically, the “Good serving cell quality” criterion indicates that the signal quality of a serving cell is less than or equal to a first threshold. The signal quality of a serving cell may be determined or estimated based on reference signal received power (RSRP), reference signal received quality (RSRQ), signal-to-noise ratio (SNR), signal-to-interference-plus-noise ratio (SINR), or hypothetic block error rate (BLER). The “Low mobility” criterion indicates that the mobility of the UE is greater than a second threshold. The mobility of the UE may be determined or estimated based on ARSRP, ARSRQ, ΔSNR, or ΔSINR. ΔRSRP=RSRP reference−RSRP measured currently, where RSRP reference can be maximal RSRP within T or RSRP measured at the starting time of T. ΔRSRQ=RSRQ reference−RSRQ measured currently, where RSRQ reference can be maximal RSRQ within T or RSRQ measured at the starting time of T. ΔSNR=SNR reference−SNR measured currently, where SNR reference can be maximal SNR within T or SNR measured at the starting time of T. ΔSINR=SINR reference−SINR measured currently, where SINR reference can be maximal SINR within T or SINR measured at the starting time of T. Note that the above-mentioned criteria parameters may be configurable by the network or predefined in 3GPP TS.

For request-based triggering of on-demand RS, the UE may transmit the request to trigger on-demand RS based on its own evaluation results (e.g., evaluation of serving cell quality and/or UE mobility) if no triggering condition is provided to the UE. Alternatively, if one or more triggering conditions are provided to the UE, the UE may transmit the request to trigger on-demand RS when any one, any subset, or all of the triggering conditions configured is/are fulfilled. For indication-based triggering of on-demand RS, the indication may indicate the time and/or frequency resource of on-demand RS, and/or the periodicity of on-demand RS. Additionally, the indication may indicate which on-demand RS type, i.e., DL or UL on-demand RS, is used if both are supported by the BS and the UE.

The minimum broadcast RS may be used by the UE in different states. For example, the minimum broadcast RS may be used in the initial cell search, or may be used for coarse time/frequency synchronization, or RRM measurement, etc., in the RRC idle/inactive mode, or may be used for beam management, RLM measurement, or RRM measurement, etc., in the RRC connected mode. The signal structure of the minimum broadcast RS may be either sequence-based or a hybrid of sequence and channel. For example, the minimum broadcast RS may consist of a primary synchronization signal (PSS), a secondary synchronization signal (SSS), and an additional synchronization signal (ASS). The SSS and the ASS may have the same power level. If a sequence-based structure is adopted for the ASS, the ASS may be a sequence, such as another SSS which is time-division multiplexed (TDMed) or frequency-division multiplexed (FDMed) with the SSS, or another sequence type which is TDMed or FDMed with the SSS. If the ASS is a channel in hybrid structure, simple coding may be used for the ASS, e.g., small block length code or rate-matching (RM) code. The minimum broadcast RS may include at least one or a set of a cell identification (ID) and a beam index. To enhance coverage of the minimum broadcast RS, the minimum broadcast RS may be transmitted in a beam sweeping manner or a repetition manner. Additionally, the minimum broadcast RS may be adapted in time, frequency, and/or spatial domains. In one example, the minimum broadcast RS may have a long periodicity (e.g., >80 ms) which is adaptable (e.g., <80 ms) if needed (e.g., the BS may determine to change the periodicity by UE's request). In another example, the minimum broadcast RS may be transmitted in N beams, and then adapted to be transmitted in M beams, where M<N, for network energy saving. The above-mentioned adaptations on the minimum broadcast RS transmission may be signaled to UE by higher layer signaling, e.g., SIB or UE-specific RRC signaling.

The on-demand RS may be used by the UE or the BS in different states. For example, the on-demand RS may be used in the RRC connected mode to assist the UE in bad condition, e.g., high mobility or low SNR, to facilitate the overall procedure for link/beam recovery, handover, etc. Alternatively, the on-demand RS may be used in the RRC idle/inactive mode and transmitted with higher transmission power to assist the UE for fine time/frequency synchronization and accessing the network. The signal structure of the on-demand RS may cover a wideband (e.g., wider than SSB bandwidth in NR) in frequency domain. In one example, a larger subcarrier spacing (SCS) may be used against inter-carrier interference due to doppler effect. In another example, a larger number of measurement resource in one shot may be used to achieve better RSRP accuracy. The signal structure of the on-demand RS may cover a short duration in time domain to shorten the required time for measurement. In one example, the on-demand RS may be transmitted once per request, i.e., a burst of RS. In another example, the on-demand RS may be transmitted with a short period within a duration, and the duration may be configured via RRC signaling.

The on-demand RS may be a type-1 on-demand RS, i.e., an UL on-demand RS, which is transmitted by the UE for link/beam recovery, handover, and/or UE-centric RRM (i.e., UL RRM). In the case where the type-1 on-demand RS is used for link/beam recovery, the on-demand RS may be transmitted to the serving cell for the BS to measure channel/beam quality, so that the BS may reconfigure new beam after measurement. The type-1 on-demand RS may be transmitted based on pre-configured occasion(s). UL-preemption may be applied for the type-1 on-demand RS transmission (i.e., the on-demand RS is transmitted when needed). The type-1 on-demand RS may be a sounding reference signal (SRS)-like sequence. Alternatively, in the case where the type-1 on-demand RS is used for link/beam recovery, the UE may identify/determine the best beam and transmits a request or an indication to make the BS change beam. In the case where the type-1 on-demand RS is used for handover, the UE may measure and identify/determine the cell with the strongest signal, and transmit a request to the target cell without the conventional handover procedure (e.g., measurement report, or handover preparation/execution, etc.). In the case where the type-1 on-demand RS is used for UL RRM, the UE may transmit the on-demand RS to allow a cell to measure and identify the UE-NW signal strength and/or the UE's location, and based on information sharing between network nodes, the handover procedure can be decided without the UE's measurement report.

The on-demand RS may be a type-2 on-demand RS, i.e., a DL on-demand RS, which is transmitted by the BS for link/beam recovery, handover, and/or RRM. In the case where the type-2 on-demand RS is used for link/beam recovery and/or handover, the UE may transmit a request to cell(s) to ask for additional RS, and the BS may transmit on-demand RS based on the UE's request. The request may explicitly or implicitly indicate the UE's type, e.g., high-mobility UE, low-SNR UE, etc. In the case where the type-2 on-demand RS is used for RRM, the on-demand RS may include at least one or a set of a cell ID and a beam index. In some implementations, the type-2 on-demand RS may be adaptable based on the UE's type/request or the UE's measurement report. For example, higher layer signaling may be used to configure a set of on-demand RS types with different structures in time, frequency, and spatial domains or different SCSs, and the UE may indicate the desired on-demand RS type via a request for triggering the on-demand RS transmission. In some implementations, the type-2 on-demand RS may be non-adaptable, i.e., same format of on-demand RS for all UE types is applied when on-demand RS is triggered.

In view of the above, the present disclosure proposes schemes pertaining to RS enhancements with respect to both the UE and the BS. According to the schemes of the present disclosure, the UE may receive minimum broadcast RS for basic DL measurement, and trigger UE-specific or cell-specific on-demand RS when needed. By applying the schemes of the present disclosure, further power saving may be realized by relaxing the RS transmissions/receptions at the UE and the BS, and the performance of radio resource utilization may be improved as well.

### Illustrative Implementations

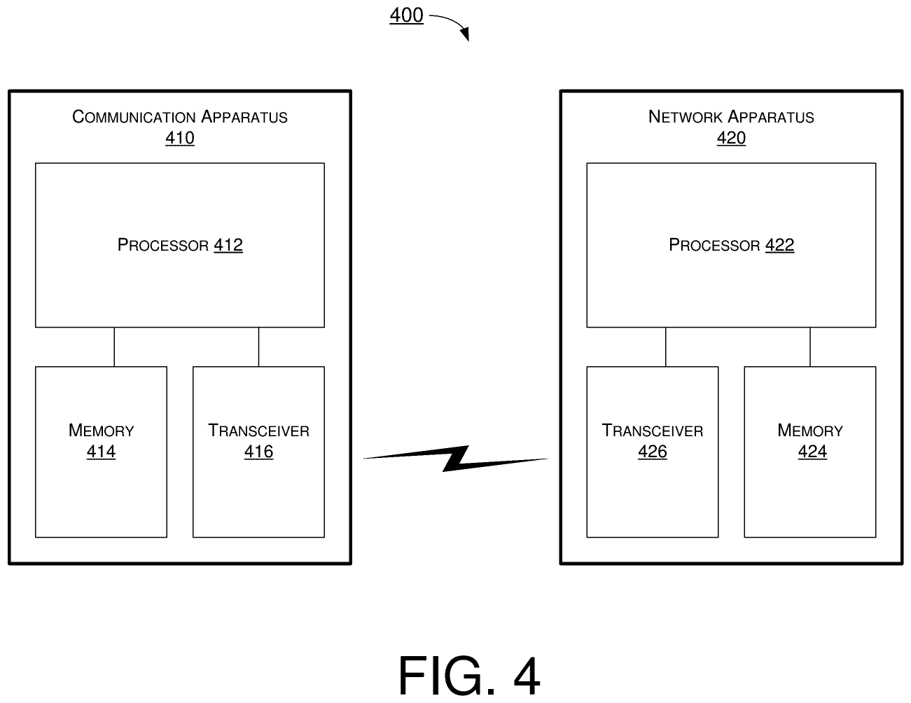

FIG. 4 illustrates an example communication system 400 having an example apparatus 410 and an example apparatus 420 in accordance with an implementation of the present disclosure. Each of apparatus 410 and apparatus 420 may perform various functions to implement schemes, techniques, processes and methods described herein pertaining to RS enhancements in mobile communications, including scenarios/schemes described above as well as processes 500 and 600 described below.

Apparatus 410 may be a part of an electronic apparatus, which may be a UE, such as a portable or mobile apparatus, a wearable apparatus, a wireless communication apparatus or a computing apparatus. For instance, apparatus 410 may be implemented in a smartphone, a smartwatch, a personal digital assistant, a digital camera, or a computing equipment such as a tablet computer, a laptop computer or a notebook computer. Apparatus 410 may also be a part of a machine type apparatus, which may be an IoT, NB-IoT, or IIoT apparatus such as an immobile or a stationary apparatus, a home apparatus, a wire communication apparatus or a computing apparatus. For instance, apparatus 410 may be implemented in a smart thermostat, a smart fridge, a smart door lock, a wireless speaker or a home control center. Alternatively, apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 410 may include at least some of those components shown in FIG. 4 such as a processor 412, for example. Apparatus 410 may further include one or more other components not pertinent to the proposed scheme of the present disclosure (e.g., internal power supply, display device and/or user interface device), and, thus, such component(s) of apparatus 410 are neither shown in FIG. 4 nor described below in the interest of simplicity and brevity.

Apparatus 420 may be a part of an electronic apparatus, which may be a network node, such as a BS, a small cell, a router or a gateway. For instance, apparatus 420 may be implemented in an eNodeB in an LTE, LTE-Advanced or LTE-Advanced Pro network or in a gNB/TRP in a 5G, NR, IoT, NB-IoT or IIoT network. Alternatively, apparatus 420 may be implemented in the form of one or more IC chips such as, for example and without limitation, one or more single-core processors, one or more multi-core processors, or one or more RISC or CISC processors. Apparatus 420 may include at least some of those components shown in FIG. 4 such as a processor 422, for example. Apparatus 420 may further include one or more other components not pertinent to the proposed scheme of the present disclosure (e.g., internal power supply, display device and/or user interface device), and, thus, such component(s) of apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks including those pertaining to RS enhancements in mobile communications in accordance with various implementations of the present disclosure.

In some implementations, apparatus 410 may also include a transceiver 416 coupled to processor 412 and capable of wirelessly transmitting and receiving data. In some implementations, transceiver 416 may be capable of wirelessly communicating with different types of wireless networks of different radio access technologies (RATs). In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, apparatus 420 may also include a transceiver 426 coupled to processor 422. Transceiver 426 may include a transceiver capable of wirelessly transmitting and receiving data. In some implementations, transceiver 426 may be capable of wirelessly communicating with different types of UEs of different RATs. In some implementations, transceiver 426 may be equipped with a plurality of antenna ports (not shown) such as, for example, four antenna ports. That is, transceiver 426 may be equipped with multiple transmit antennas and multiple receive antennas for MIMO wireless communications.

In some implementations, apparatus 410 may further include a memory 414 coupled to processor 412 and capable of being accessed by processor 412 and storing data therein. In some implementations, apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 414 and memory 424 may include a universal integrated circuit card (U ICC).

Each of apparatus 410 and apparatus 420 may be a communication entity capable of communicating with each other using various proposed schemes in accordance with the present disclosure. For illustrative purposes and without limitation, a description of capabilities of apparatus 410, as a UE, and apparatus 420, as a network node (e.g., BS), is provided below.

Under certain proposed schemes in accordance with the present disclosure with respect to RS enhancements in mobile communications, processor 412 of apparatus 410, implemented in or as a UE, may receive, via transceiver 416, a minimum broadcast RS from apparatus 420, implemented in or as a network node. Processor 412 may perform, via transceiver 416, basic DL measurement based on the minimum broadcast RS. Processor 412 may receive or transmit, via transceiver 416, an on-demand RS from or to the network node in a case that a triggering condition is fulfilled. Additionally, processor 412 may perform, via transceiver 416, additional DL/UL measurement based on the on-demand RS.

In some implementations, when the on-demand RS is triggered by the UE, the triggering condition may indicate at least one of the following: (1) the signal quality of a serving cell is less than or equal to a first threshold, and (2) the mobility of a UE is greater than a second threshold.

In some implementations, when the on-demand RS is triggered by the network node, the network node may determine whether the triggering condition is fulfilled based on at least one of the following: (1) the mobility of the UE, (2) the location of the UE, and (3) the channel condition of the UE.

In some implementations, the basic DL measurement may be performed for at least one of the following: (1) initial cell search, (2) time and/or frequency synchronization, (3) beam management, (4) RLM, and (5) RRM.

In some implementations, the additional DL/UL measurement may be performed for at least one of the following: (1) link or beam recovery, (2) handover procedure, and (3) RRM.

In some implementations, the minimum broadcast RS and the on-demand RS may be received via the same radio or different radios of transceiver 416. For example, the minimum broadcast RS and the on-demand RS may be received by a single-radio UE via its single radio (e.g., main radio, such as a high-power receiver that is capable of complicated radio frequency (RF) signal processing) or by a dual-radio UE via the same radio (e.g., main radio, or secondary radio, such as a low-power receiver that is capable of simple RF signal processing). Alternatively, the minimum broadcast RS may be received by a dual-radio UE via a first radio of the UE, and the on-demand RS may be received via a second radio of the UE.

In some implementations, processor 412 may also report, via transceiver 416, capability information indicating whether apparatus 410 supports the on-demand RS to the network node, and receive, via transceiver 416, configuration of time and frequency resources for the on-demand RS from the network node. Additionally, processor 412 may receive, via transceiver 416, configuration of the triggering condition from the network node.

In some implementations, processor 412 may also transmit, via transceiver 416, a request triggering the on-demand RS to the network node when the triggering condition is fulfilled (i.e., the case of on-demand RS triggered by a UE). Alternatively, processor 412 may also receive, via transceiver 416, an indication of triggering the on-demand RS from the network node (i.e., the case of on-demand RS triggered by a BS).

In some implementations, each of the minimum broadcast RS and the on-demand RS may include at least one of the following: (1) a cell ID, and (2) a beam index.

### Illustrative Processes

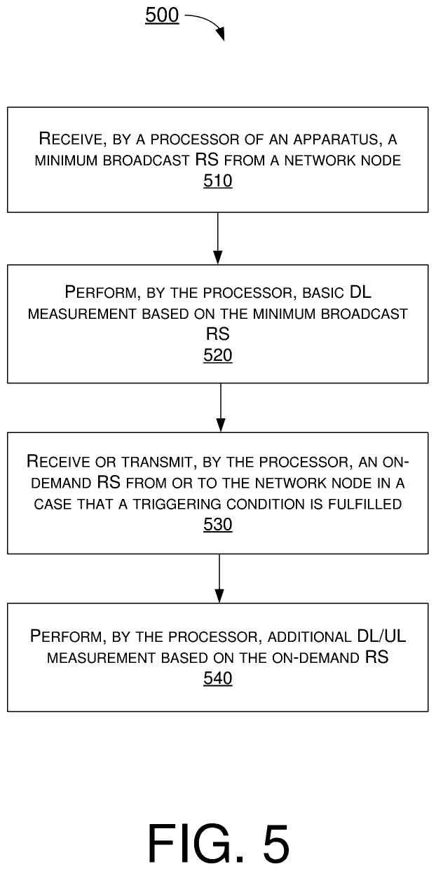

FIG. 5 illustrates an example process 500 in accordance with an implementation of the present disclosure. Process 500 may represent an aspect of implementing various proposed designs, concepts, schemes, systems and methods described above, whether partially or entirely, including those described above. More specifically, process 500 may represent an aspect of the proposed concepts and schemes pertaining to RS enhancements in mobile communications. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively in a different order. Furthermore, one or more of the blocks/sub-blocks of process 500 may be executed iteratively. Process 500 may be implemented by or in apparatus 410 as well as any variations thereof. Solely for illustrative purposes and without limiting the scope, process 500 is described below in the context of apparatus 410 as a UE. Process 500 may begin at block 510.

At 510, process 500 may involve processor 412 of apparatus 410, implemented in or as a UE, receiving, via transceiver 416, a minimum broadcast RS from a network node. Process 500 may proceed from 510 to 520.

At 520, process 500 may involve processor 412 performing, via transceiver 416, basic DL measurement based on the minimum broadcast RS. Process 500 may proceed from 520 to 530.

At 530, process 500 may involve processor 412 receiving or transmitting, via transceiver 416, an on-demand RS from or to the network node in a case that a triggering condition is fulfilled. Process 500 may proceed from 530 to 540.

At 540, process 500 may involve processor 412 performing, via transceiver 416, additional DL/UL measurement based on the on-demand RS.

In some implementations, when the on-demand RS is triggered by the UE, the triggering condition may indicate at least one of the following: (1) the signal quality of a serving cell is less than or equal to a first threshold, and (2) the mobility of a UE is greater than a second threshold.

In some implementations, when the on-demand RS is triggered by the network node, the network node may determine whether the triggering condition is fulfilled based on at least one of the following: (1) the mobility of the UE, (2) the location of the UE, and (3) the channel condition of the UE.

In some implementations, the basic DL measurement may be performed for at least one of the following: (1) initial cell search, (2) time and/or frequency synchronization, (3) beam management, (4) RLM, and (5) RRM.

In some implementations, the additional DL/UL measurement may be performed for at least one of the following: (1) link or beam recovery, (2) handover procedure, and (3) RRM.

In some implementations, the minimum broadcast RS and the on-demand RS may be received via the same radio or different radios of transceiver 416.

In some implementations, process 500 may further involve processor 412 reporting, via transceiver 416, capability information indicating whether apparatus 410 supports the on-demand RS to the network node, and receiving, via transceiver 416, configuration of time and frequency resources for the on-demand RS from the network node. Additionally, process 500 may involve processor 412 receiving, via transceiver 416, configuration of the triggering condition from the network node.

In some implementations, process 500 may further involve processor 412 transmitting, via transceiver 416, a request triggering the on-demand RS to the BS when the triggering condition is fulfilled (i.e., the case of on-demand RS triggered by the UE). Alternatively, process 500 may further involve processor 412 receiving, via transceiver 416, an indication of triggering the on-demand RS from the network node (i.e., the case of on-demand RS triggered by a BS).

In some implementations, each of the minimum broadcast RS and the on-demand RS may include at least one of the following: (1) a cell ID, and (2) a beam index.

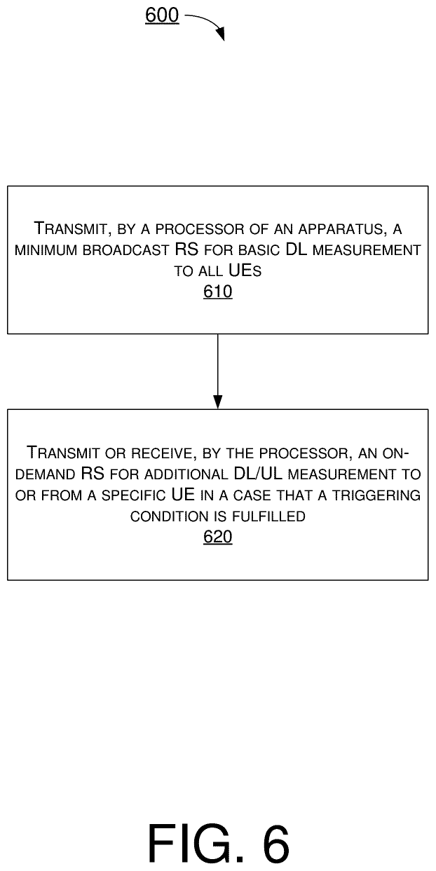

FIG. 6 illustrates an example process 600 in accordance with an implementation of the present disclosure. Process 600 may represent an aspect of implementing various proposed designs, concepts, schemes, systems and methods described above, whether partially or entirely, including those described above. More specifically, process 600 may represent an aspect of the proposed concepts and schemes pertaining to RS enhancements in mobile communications. Process 600 may include one or more operations, actions, or functions as illustrated by one or more of blocks 610 and 620. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively in a different order. Furthermore, one or more of the blocks/sub-blocks of process 600 may be executed iteratively. Process 600 may be implemented by or in apparatus 420 as well as any variations thereof. Solely for illustrative purposes and without limiting the scope, process 600 is described below in the context of apparatus 420 as a network node (e.g., a BS). Process 600 may begin at block 610.

At 610, process 600 may involve processor 422 of apparatus 420, implemented in or as a network node, transmitting, via transceiver 426, a minimum broadcast RS for basic DL measurement to all UEs. Process 600 may proceed from 610 to 620.

At 620, process 600 may involve processor 422 transmitting or receiving, via transceiver 426, an on-demand RS for additional DL/UL measurement to or from a specific UE in a case that a triggering condition is fulfilled.

In some implementations, process 600 may further involve processor 422 determining whether the triggering condition is fulfilled based on at least one of the following: (1) the mobility of the specific UE, (2) the location of the specific UE, and (3) the channel condition of the specific UE.

In some implementations, the basic DL measurement may be performed for at least one of the following: (1) initial cell search, (2) time and/or frequency synchronization, (3) beam management, (4) RLM, and (5) RRM.

In some implementations, the additional DL/UL measurement may be performed for at least one of the following: (1) link or beam recovery, (2) handover procedure, and (3) RRM.

In some implementations, process 600 may further involve processor 422 receiving, via transceiver 426, capability information indicating whether the specific UE supports the on-demand RS from the specific UE, and transmitting, via transceiver 426, configuration of time and frequency resources for the on-demand RS to the specific UE. Additionally, process 600 may involve processor 422 transmitting, via transceiver 426, configuration of the triggering condition to the specific UE.

In some implementations, process 600 may further involve processor 422 receiving, via transceiver 426, a request triggering the on-demand RS from the specific UE. Alternatively, process 600 may further involve processor 422 transmitting, via transceiver 426, an indication of triggering the on-demand RS to the specific UE in the case that the triggering condition is fulfilled.

In some implementations, each of the minimum broadcast RS and the on-demand RS may include at least one of the following: (1) a cell ID, and (2) a beam index.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a minimum broadcast reference signal (RS) from a network node;
performing, by the processor, basic downlink (DL) measurement based on the minimum broadcast RS;
receiving or transmitting, by the processor, an on-demand RS from or to the network node in a case that a triggering condition is fulfilled; and
performing, by the processor, additional DL or uplink (UL) measurement based on the on-demand RS.

2. The method of claim 1, wherein the triggering condition indicates at least one of the following:
a signal quality of a serving cell is less than or equal to a first threshold; and
a mobility of the apparatus is greater than a second threshold.

3. The method of claim 1, wherein the basic DL measurement is performed for at least one of the following:
an initial cell search;
a time or frequency synchronization;
a beam management;
a radio link monitoring (RLM); and
a radio resource management (RRM); and
wherein the additional DL or UL measurement is performed for at least one of the following:
a link or beam recovery;
a handover procedure; and
a radio resource management (RRM).

4. The method of claim 1, wherein the minimum broadcast RS is received via a first radio of the apparatus, and the on-demand RS is received via a second radio of the apparatus.

5. The method of claim 1, further comprising:
reporting, by the processor, capability information indicating whether the apparatus supports the on-demand RS to the network node;
receiving, by the processor, configuration of time and frequency resources for the on-demand RS from the network node; and
receiving, by the processor, configuration of the triggering condition from the network node.

6. The method of claim 1, further comprising:
transmitting, by the processor, a request triggering the on-demand RS to the network node in the case that the triggering condition is fulfilled; or
receiving, by the processor, an indication of triggering the on-demand RS from the network node.

7. The method of claim 1, wherein each of the minimum broadcast RS and the on-demand RS comprises at least one of the following:
a cell identification (ID); and
a beam index.

8. A method, comprising:
transmitting, by a processor of an apparatus, a minimum broadcast reference signal (RS) for basic downlink (DL) measurement to all user equipments (UEs); and
transmitting or receiving, by the processor, an on-demand RS for additional DL or uplink (UL) measurement to or from a specific UE in a case that a triggering condition is fulfilled.

9. The method of claim 8, further comprising:
determining, by the processor, whether the triggering condition is fulfilled based on at least one of the following:
a mobility of the specific UE;
a location of the specific UE; and
a channel condition of the specific UE.

10. The method of claim 8, wherein the basic DL measurement is performed for at least one of the following:
an initial cell search;
a time or frequency synchronization;
a beam management;
a radio link monitoring (RLM); and
a radio resource management (RRM); and
wherein the additional DL or UL measurement is performed for at least one of the following:
a link or beam recovery;
a handover procedure; and
a radio resource management (RRM).

11. The method of claim 8, further comprising:
receiving, by the processor, capability information indicating whether the specific UE supports the on-demand RS from the specific UE;
transmitting, by the processor, configuration of time and frequency resources for the on-demand RS to the specific UE; and
transmitting, by the processor, configuration of the triggering condition to the specific UE.

12. The method of claim 8, further comprising:
receiving, by the processor, a request triggering the on-demand RS from the specific UE; or
transmitting, by the processor, an indication of triggering the on-demand RS to the specific UE in the case that the triggering condition is fulfilled.

13. The method of claim 8, wherein each of the minimum broadcast RS and the on-demand RS comprises at least one of the following:
a cell identification (ID); and
a beam index.

14. An apparatus, comprising:
a transceiver which, during operation, wirelessly communicates with a network node of a wireless network; and
a processor communicatively coupled to the transceiver such that, during operation, the processor performs operations comprising:
receiving, via the transceiver, a minimum broadcast reference signal (RS) from the network node;
performing, via the transceiver, basic downlink (DL) measurement based on the minimum broadcast RS;
receiving or transmitting, via the transceiver, an on-demand RS from or to the network node in a case that a triggering condition is fulfilled; and
performing, via the transceiver, additional DL or uplink (UL) measurement based on the on-demand RS.

15. The apparatus of claim 14, wherein the triggering condition indicates at least one of the following:
a signal quality of a serving cell is less than or equal to a first threshold; and
a mobility of the apparatus is greater than a second threshold.

16. The apparatus of claim 14, wherein the basic DL measurement is performed for at least one of the following:
an initial cell search;
a time or frequency synchronization;
a beam management;
a radio link monitoring (RLM); and
a radio resource management (RRM); and
wherein the additional DL or UL measurement is performed for at least one of the following:
a link or beam recovery;
a handover procedure; and
a radio resource management (RRM).

17. The apparatus of claim 14, wherein the minimum broadcast RS is received via a first radio of the transceiver, and the on-demand RS is received via a second radio of the transceiver.

18. The apparatus of claim 14, wherein, during operation, the processor further performs operations comprising:
reporting, via the transceiver, capability information indicating whether the apparatus supports the on-demand RS to the network node;
receiving, via the transceiver, configuration of time and frequency resources for the on-demand RS from the network node; and
receiving, via the transceiver, configuration of the triggering condition from the network node.

19. The apparatus of claim 14, wherein, during operation, the processor further performs operations comprising:
transmitting, via the transceiver, a request triggering the on-demand RS to the network node in the case that the triggering condition is fulfilled; or
receiving, via the transceiver, an indication of triggering the on-demand RS from the network node.

20. The apparatus of claim 14, wherein each of the minimum broadcast RS and the on-demand RS comprises at least one of the following:
a cell identification (ID); and
a beam index.
